(19) United States
(12) Patent Application Publication
(10) Pub. No.: US 2020/0034723 A1
(43) Pub. Date: Jan. 30, 2020

(54) CONFIGURATION MANAGEMENT DEVICE, CONFIGURATION MANAGEMENT METHOD, AND RECORDING MEDIUM

(71) Applicant: NEC CORPORATION, Tokyo (JP)

(72) Inventor: Manabu NAKANOYA, Tokyo (JP)

(73) Assignee: NEC CORPORATION, Tokyo (JP)

(21) Appl. No.: 16/496,749

(22) PCT Filed: Mar. 19, 2018
(86) PCT No.: PCT/JP2018/010768

§ 371 Date: Sep. 23, 2019

(30) Foreign Application Priority Data
Mar. 24, 2017 (JP) 2017-058727

(51) Int. Cl. G06N 5/04; G06N 20/00

(52) U.S. Cl. CPC G06N 5/04; G06N 20/00

(57) ABSTRACT

A configuration management device 10 is provided with a generation means 11 for executing supervised machine learning on the basis of feature information that indicates the features of text data in which configuration information of a system is included and learning data in which the text data and the configuration information of the system are included, and thereby generating a prediction model used in predicting the configuration information of a system included in input data from input data that is the text data having the features indicated by the feature information.

### TECHNICAL FIELD

The present invention relates to a configuration management device, configuration management method, and recording medium.

### BACKGROUND ART

A purpose of configuration management is to operate a management-target system efficiently. For efficient operation, it is required to grasp a past state and a current state of components of the management-target system at granularity suitable for a management level.

For example, in a case of hardware in which a recovery procedure at a time of failure is a simple component replacement, a response at the time of failure in an operation management manual is determined in advance to be component replacement. That is, hardware configuration information may not be particularly managed. In a case of handling only the above hardware, an administrator only needs to manage information indicating logical attributes such as inventory of individual hardware and licenses corresponding to the hardware.

However, considering to a case where it is necessary to correct or modify software installed in the hardware in the event of failure, addition of a function, and the like, it is required to manage the software to be corrected or modified, including a state of the software.

Software tools are provided that automatically perform the above-described change operations on software. When the software tools are utilized, operation management may be performed more efficiently. The importance of managing software configurations is also high, as the use of software tools is expected to increase.

NPL (Non Patent Literature) 1 and NPL 2 describe examples of software tools (automatic construction tools) that automatically perform the above-described construction operation and change operation of software. The automatic construction tools described in NPL 1 and NPL 2 are tools that automatically install software and set software by using, as an input, configuration management information after construction and configuration management information after change.

In this specification, a format of configuration management information is also referred to as a modeling language. The format of the configuration management information to be inputted is different for each software tool.

When the format of the configuration management information and the format required by the software tool are matched, configuration change and construction operation are easily performed automatically. Further, using software tools to perform construction reduces a risk of erroneous setting due to mistakes in manual construction operation. That is, the use of the software tool is also effective in maintaining the consistency between the configuration management information and a configuration management target state.

Further, NPL 3 describes a standard notation (specification of a modeling language) for describing configuration information of an information technology (IT) system constructed in a cloud system. Using the standard notation described in NPL 3 reduces differences between configuration management tools and between cloud environments in which the IT system is constructed, allowing realization of versatile management of configuration management information.

Generation of configuration management information and maintenance of consistency between generated configuration management information and a configuration management target is important in system operation management. This is because current configuration management information of a management-target system is the most basic information for executing a plan to change the management-target system and a plan to recover the management-target system from failure. That is, if the current configuration management information is not grasped correctly, it becomes impossible to correctly plan and execute a change operation and a recovery operation.

For example, a person in charge for performing configuration management is prepared in order to reliably perform the change operation and the recovery operation described above. The prepared person in charge manually performs reflection on configuration management information and manages a status of configuration management information for each of various configuration change events in system operation, such as a construction result of an initial design, a change request for adding functions, and the like, and a recovery operation result at a time of failure.

However, management of the configuration management information becomes complicated in a case where the configuration management information to be managed includes many setting values and program codes, in a case where the number of items of the configuration management information itself to be managed is large, and in a case where there is a large amount of configuration change events and the like requiring a change of the configuration management information. Complicated management of the configuration management information easily causes destruction of the configuration management information due to omission of recording or an operation error.

There are known a lot of related researches and related products for management of configuration management information for preventing occurrence of destruction of configuration management information described above. For example, PTL (Patent Literature) 1 describes a resource management method of searching for a configuration file described in a structured language such as an extensible markup language (XML) and arranged in an operating server or the like, and converting contents of the searched configuration file into configuration definition information described in a specific modeling language.

Further, PTL 2 describes a computer that automatically grasps a setting of an operating system (OS) by executing a command prepared in advance on a server as a configuration management target.

Further, PTL 3 describes an information processing device capable of promoting efficiency of an operation related to a configuration change of a system. The information processing device described in PTL 3 includes a replacing unit that acquires, from configuration information in which a configuration of a modification-target system is defined, unique information of the modification-target system corresponding to a variable name included in extracted procedure information.

In addition, NPL 4 describes a technique of searching a management-target system for software in which analysis procedures and the like are registered in advance, and grasping the presence or absence of software installation, a setting of software, dependency between software, and the like.

In addition, NPL 5 describes a technique of structuring information of a configuration file stored in a server as a configuration management target, by modeling syntax of a configuration file as an analysis target by using a modeling language to which Backus-Naur form (BNF) is applied. The technique described in NPL 5 refers to and changes settings via a command line interface (CLI), by using information of the structured configuration file with a setting item as a key.

All of the above techniques and products perform processing to analyze text data such as settings (configuration file) and command execution results placed as files in the OS, and convert contents of the analyzed text data into configuration management information.

In the analysis processing in the above techniques and products, an analysis target is specifically selected in advance. That is, text data strictly conforming to the descriptive syntax employed in the selected analysis target is analyzed. In the above techniques and products, for example, a parsing program composed of one or more static rules is used.

Further, in the field of natural language processing where text data described in an ambiguous grammar or text data described in an incorrect grammar is also required to be analyzed with the highest possible accuracy, a text analysis program configured by machine learning is often used.

The above text analysis program includes a program that is generated on the basis of: for example, a collection of sets of text data of a type of an analysis target and preferable analysis result data corresponding to the text data; and a characteristic that appears in text data that characterizes a structure of the text data of the type of the analysis target.

That is, the set of the text data and the analysis result data is supervised learning data. In addition, representative structures of text data to be the characteristic are classified parts of speech and dependencies. Note that a characteristic that appears in text data is also called a feature.

As a representative method that can generate the above program, there are a structured support vector machine (SSVM), a conditional random field (CRF), and the like.

### CITATION LIST

### Patent Literature

PTL 1: Japanese Patent No. 4185030

PTL 2: Japanese Patent Application Laid-Open No. 2001-084132

PTL 3: International Publication No. 2012/124018

### Non Patent Literature

NPL 1: “Puppet”, [online], Puppet, [searched on Mar. 19, 2017], Internet <https://puppet.com/>

NPL 2: “Ansible”, [online], Red Hat, [searched on Mar. 19, 2017], Internet <https://www.ansible.com/>

NPL 3: “OASIS Topology and Orchestration Specification for Cloud Application s”, [online], OASIS, [searched on Mar. 19, 2017], Internet <https://www.oasis-open.org/committees/tc_home.php?wg_abbrev=tosca#overview>

NPL 4: “Tivoli Application Dependency Discovery Manager”, [online], IBM, [searched on Mar. 19, 2017], Internet <https://www.ibm.com/developerworks/servicemanagement/bsm/taddm/>

NPL 5: “Augeas”, [online], Red Hat, [searched on Mar. 19, 2017], Internet <http://augeas.net/>

### SUMMARY OF INVENTION

### Technical Problem

In the resource management method described in PTL 1, components grasped from a configuration management target are limited to components represented by a configuration file conforming to a specific format such as XML.

In addition, also in the computer described in PTL 2, components grasped from a configuration management target are limited to setting information of the OS obtained from a command execution result assumed in advance. Further, also in the information processing device described in PTL 3, an acquisition destination of unique information of the modification-target system is limited to configuration information in which a configuration of the modification-target system is defined.

Further, the technique described in NPL 4 assumes components grasped from a configuration management target in advance, in units of specific application software. That is, the technique described in NPL 4 cannot process software other than the target application software.

Further, in the technique described in NPL 5, only a configuration file for which BNF has been generated in advance is the target of processing. That is, the technique described in NPL 5 cannot refer to or change contents described in an unknown configuration file.

That is, the above techniques and products grasp configuration management information from a management target, and manage the grasped configuration management information. In addition, the above techniques and products specifically assume a target for grasping configuration management information as a premise of processing, and generate in advance procedures and methods for grasping configuration management information according to the assumed target.

Thus, the above techniques and products have two problems. The first problem is that configuration management information cannot be grasped from configuration management targets such as unknown software and configuration files.

The second problem is that the total cost of managing configuration management information as a configuration management target is large. For example, the cost of generating and maintaining a dedicated procedure or method for grasping configuration management information for each component as a configuration management target is relatively large.

Therefore, in a case of generating and maintaining a dedicated procedure or method for grasping configuration management information even for software and configuration files that are low in use frequency or software and configuration files developed by specific organizations or individuals, the total cost may exceed the cost of manually managing the configuration of the management target directly.

Further, NPL 1 to NPL 3 do not describe means capable of solving the above two problems.

### Object of Invention

Accordingly, an object of the present invention is to provide a configuration management device, a configuration management method, and a recording medium capable of grasping configuration management information from an unknown configuration management target at low cost, for solving the problems described above.

### Solution to Problem

A configuration management device according to the present invention includes: a generation means that executes supervised machine learning on the basis of feature information that indicates the features of text data in which configuration information of a system is included and learning data in which the text data and the configuration information of the system are included, and thereby generates a prediction model used in predicting the configuration information of a system included in input data from input data that is the text data having the features indicated by the feature information.

A configuration management method according to the present invention includes: executing supervised machine learning on the basis of feature information that indicates the features of text data in which configuration information of a system is included and learning data in which the text data and the configuration information of the system are included, and thereby generating a prediction model used in predicting the configuration information of a system included in input data from input data that is the text data having the features indicated by the feature information.

A non-transitory computer readable recording medium with a recorded configuration management program according to the present invention stores a configuration management program that executes, when executed on a computer, supervised machine learning on the basis of feature information that indicates the features of text data in which configuration information of a system is included and learning data in which the text data and the configuration information of the system are included, and thereby generates a prediction model used in predicting the configuration information of a system included in input data from input data that is the text data having the features indicated by the feature information.

### Advantageous Effects of Invention

According to the present invention, configuration management information can be grasped from an unknown configuration management target at low cost.

### BRIEF DESCRIPTION OF DRAWINGS

FIG. 1 is a block diagram showing a configuration example of a first exemplary embodiment of a configuration management device according to the present invention.

FIG. 2 is an explanatory diagram showing an example of a configuration file as text data.

FIG. 3 is an explanatory diagram showing an example of correspondence between setting items and setting values.

FIG. 4 is an explanatory diagram showing an example of a labeled graph representing a structure of text data.

FIG. 5 is an explanatory diagram showing an example definition of features used in machine learning of the present exemplary embodiment.

FIG. 6 is an explanatory diagram showing an example of text data acquired by a management target monitoring unit 140.

FIG. 7 is an explanatory diagram showing an example of labeled-graph data predicted by a configuration prediction unit 130.

FIG. 8 is a flowchart showing an operation of a modeling language conversion process by an information conversion unit 150 of the first exemplary embodiment.

FIG. 9 is an explanatory diagram showing an example of a template file and a variable dictionary outputted by the information conversion unit 150.

FIG. 10 is a flowchart showing an operation of a configuration information output process by a configuration management device 100 of the first exemplary embodiment.

FIG. 11 is a block diagram showing a configuration example of a second exemplary embodiment of a configuration management device according to the present invention.

FIG. 12 is an explanatory diagram showing an example of learning data stored in a learning data (label) storage unit 310.

FIG. 13 is a flowchart showing an operation of a graph conversion process by a graphing unit 170 of the second exemplary embodiment.

FIG. 14 is a flowchart showing an operation of a configuration information output process by a configuration management device 101 of the second exemplary embodiment.

FIG. 15 is a block diagram showing a configuration example of a third exemplary embodiment of a configuration management device according to the present invention.

FIG. 16 is a flowchart showing an operation of a configuration information output process by a configuration management device 102 of the third exemplary embodiment.

FIG. 17 is a block diagram showing an outline of a configuration management device according to the present invention.

### DESCRIPTION OF EMBODIMENTS

### First Exemplary Embodiment

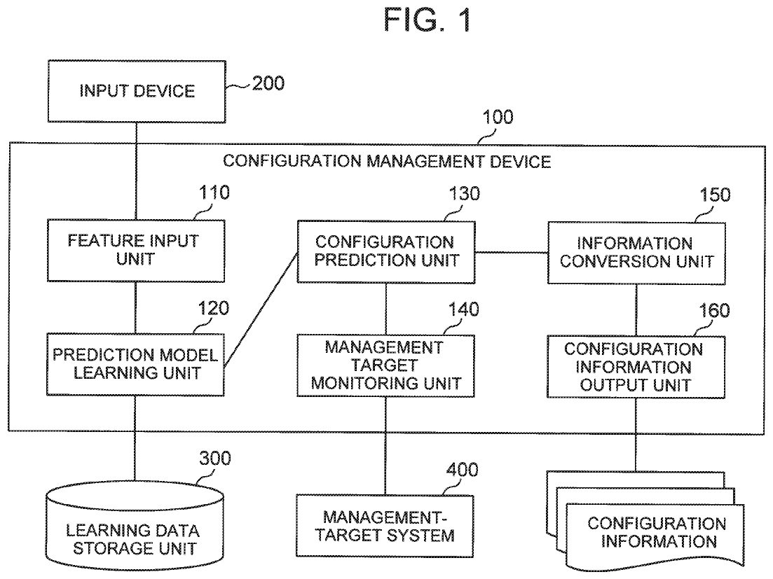

Hereinafter, an exemplary embodiment of the present invention will be described with reference to the drawings. FIG. 1 is a block diagram showing a configuration example of a first exemplary embodiment of a configuration management device according to the present invention.

A configuration management device 100 of the present exemplary embodiment can generate configuration management information described in accordance with a modeling language specified by a user, on the basis of text data that can be obtained from a system and suggests a system configuration that is represented in various formats.

Specifically, the configuration management device 100 performs machine learning on the basis of data indicating text data suggesting a system configuration and characteristic quantity (features) of a text data group, and on the basis of teacher data unique to text data in which configuration information such as a labeled graph is classified or structured.

Using a prediction model obtained by machine learning, the configuration management device 100 predicts meaning of description contents of text data that is acquired from the configuration-management-target system and suggests a configuration. Then, the configuration management device 100 generates configuration management information according to a modeling language specified by the user from the data indicating the prediction result, by executing a conversion process for each pre-registered modeling language.

As shown in FIG. 1, the configuration management device 100 according to the present exemplary embodiment includes a feature input unit 110, a prediction model learning unit 120, a configuration prediction unit 130, a management target monitoring unit 140, an information conversion unit 150, and a configuration information output unit 160.

Further, as shown in FIG. 1, an input device 200, a learning data storage unit 300, and a management-target system 400 are connected to the configuration management device 100 of the present exemplary embodiment. Information is inputted from the input device 200 to the configuration management device 100. Further, the configuration information output unit 160 outputs generated configuration information (configuration management information).

The feature input unit 110 is inputted with feature data indicating an arrangement pattern of control codes and a relative positional relationship between a general word string and a control code found in text data suggesting a configuration, for example, such as a system configuration file and a command execution result.

The user inputs, to the input device 200, a feature (characteristic) collection required to learn a prediction model. The input device 200 inputs the inputted feature collection to the feature input unit 110. The feature input unit 110 inputs the inputted feature collection to the prediction model learning unit 120.

In addition to the input of the feature collection, the user prepares for prediction of configuration information by using learning data stored in the learning data storage unit 300. Specifically, the prediction model learning unit 120 generates a prediction model by performing machine learning on the basis of the learning data stored in the learning data storage unit 300 and on the basis of the inputted feature collection.

The prediction model learning unit 120 generates a specific machine learning model to be used to identify text data. The prediction model learning unit 120 uses text data such as a configuration file and an execution result of a setting confirmation command as learning data, to learn meaning of word elements in the text data in the configuration information and structural positioning between setting items.

In addition, the prediction model learning unit 120 uses each word including a control code in the learning data as teacher data, to generate a prediction model for predicting a system configuration from unknown text data that has meaning and a relationship between words in the configuration information and suggests a configuration.

Meanwhile, the prediction model learning unit 120 may execute the learning process by using existing machine learning technology such as SSVM or CRF.

In the prediction model generated by the prediction model learning unit 120, a structure of text data suggesting configuration information such as a configuration file and a command execution result, and the meaning of each component in the text data are predicted.

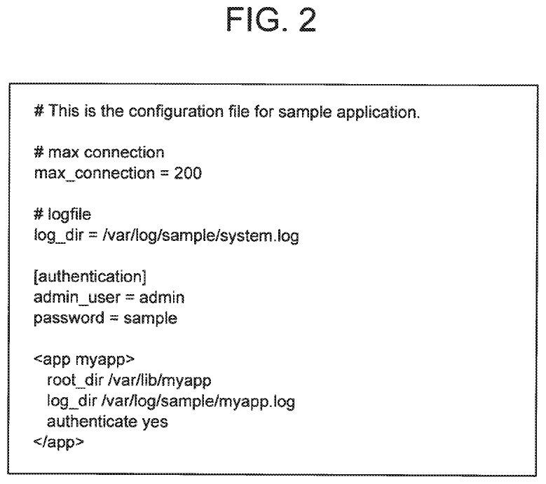

FIG. 2 is an explanatory diagram showing an example of a configuration file as text data. Note that the text data shown in FIG. 2 is a part of learning data.

Configuration information suggested by a configuration file, which is text data shown in FIG. 2, indicates setting contents of software. The text data shown in FIG. 2 describes setting items, setting values, and relationships between setting items and setting values.

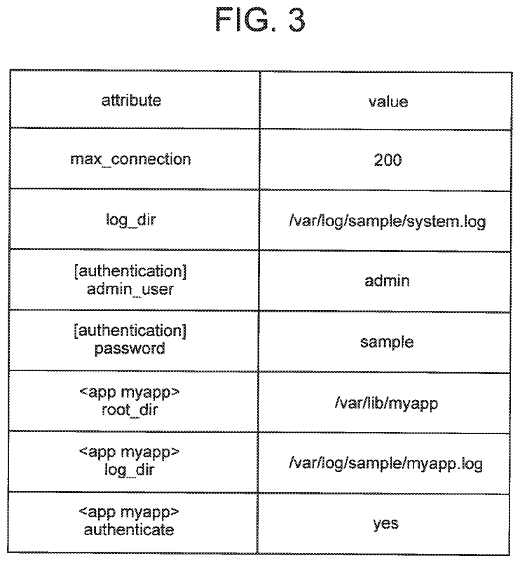

FIG. 3 is an explanatory diagram showing an example of correspondence between setting items and setting values. The relationship between setting items and setting values shown in FIG. 2 is structured as shown in FIG. 3. Note that “attribute” shown in FIG. 3 indicates a setting item, and “value” indicates a setting value, individually.

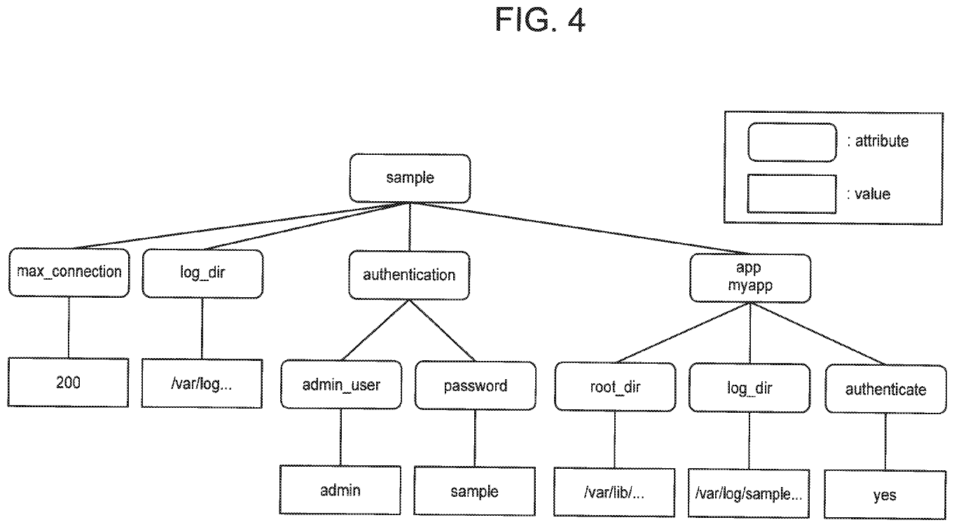

FIG. 4 is an explanatory diagram showing an example of a labeled graph representing a structure of text data. The labeled graph shown in FIG. 4 represents a hierarchical structure of setting items and setting values.

The hierarchical structure between the setting items and the hierarchical structure between the setting values shown in FIG. 3 are represented by a graph as shown in FIG. 4. In addition, as shown in FIG. 4, a rounded square represents “attribute”, and a rectangle represents “value”, individually.

Referring to FIGS. 3 and 4, text data in which setting items and setting values are described is organized as a labeled graph having classifications such as attribute and value as labels, with elements (tokens) such as “max_connection” and “200” as nodes. That is, predicting a labeled graph representing configuration information as shown in FIG. 4 from text data suggesting configuration information as shown in FIG. 2 is a role of the prediction model generated by the prediction model learning unit 120.

Therefore, the learning data storage unit 300 stores a collection of sets of text data such as a configuration file suggesting configuration information as shown in FIG. 2 and a labeled graph as teacher data as shown in FIG. 4.

For the problem of predicting data as shown in FIG. 4 on the basis of text data as shown in FIG. 2, as a prediction model of existing machine learning, there are utilized sequence labeling and a structure estimation model that are used in part-of-speech classification, dependency analysis of natural language processing, and the like.

However, text data that is to be an input to the prediction model of the present exemplary embodiment indicates a language other than natural language. Therefore, in the present exemplary embodiment, the labels and the features are required to be designed from a viewpoint different from general natural language processing. For example, in a case of labels, as shown in FIG. 3, special labels such as “attribute” and “value” are used.

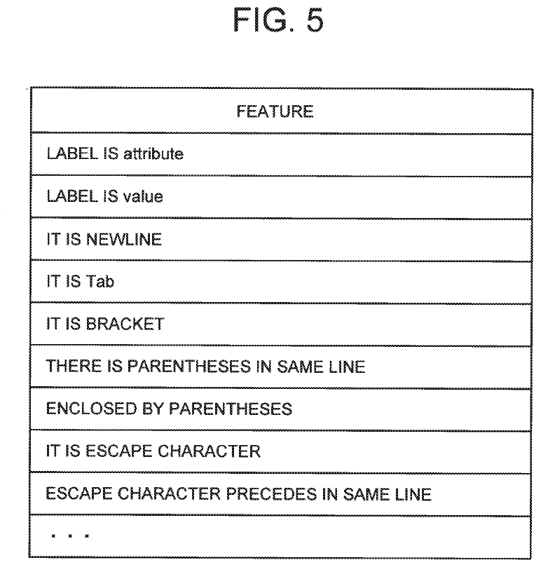

Further, special contents are also used for features. FIG. 5 is an explanatory diagram showing an example definition of features used in machine learning of the present exemplary embodiment.

As shown in FIG. 5, in the present exemplary embodiment, control characters such as a newline, a space, and a tab, and positional relationships with control characters are used as features. Further, in the present exemplary embodiment, a condition for extracting a characteristic of a portion that is generally called a comment and does not affect effective settings is described as a feature. For example, “an escape character (”#“, “;”, and the like) precedes in the same line” shown in FIG. 5 is a condition for extracting a characteristic of a portion called a comment.

Further, as shown in FIG. 5, in the present exemplary embodiment, the presence or absence of brackets (“{ }”, “[ ]”, or the like) representing a structure between elements in text data and a relative position of the brackets are used as features.

Note that features often used in general natural language processing but not described in FIG. 5 may be added to the features used in the present exemplary embodiment. For example, a feature that a previous token contains a specific character string may be added. A learned prediction model generated by the prediction model learning unit 120 is inputted to the configuration prediction unit 130.

The management target monitoring unit 140 has a function of acquiring text data suggesting configuration information of the management-target system 400. The management-target system 400 is a management-target system of the configuration management device 100.

The configuration prediction unit 130 receives text data acquired by the management target monitoring unit 140 from the management target monitoring unit 140. Next, the configuration prediction unit 130 predicts labeled-graph data as shown in FIG. 4, on the basis of the prediction model inputted from the prediction model learning unit 120 and the text data.

Note that the text data received by the configuration prediction unit 130 does not necessarily conform to a particular syntax or language. In addition, the configuration prediction unit 130 may receive a plurality of configuration files and a list of text data in one-to-one correspondence with command execution results.

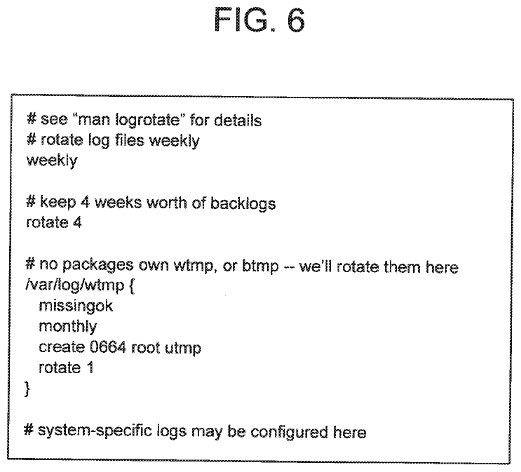

FIG. 6 is an explanatory diagram showing an example of text data acquired by the management target monitoring unit 140. Text data shown in FIG. 6 is inputted to the prediction model.

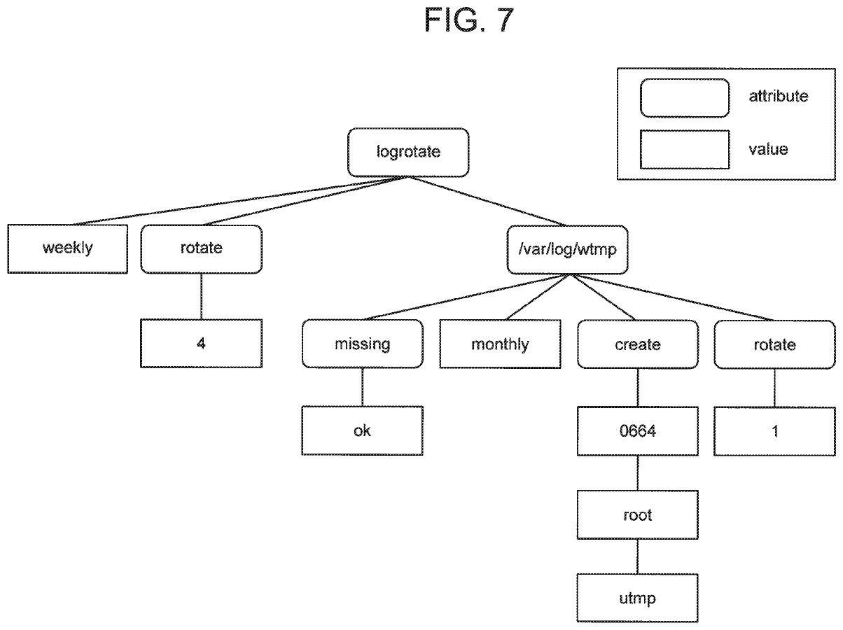

FIG. 7 is an explanatory diagram showing an example of labeled-graph data predicted by the configuration prediction unit 130. The data shown in FIG. 7 is data predicted by a prediction model with the text data shown in FIG. 6 as an input. Note that meaning of a notation described in FIG. 7 is similar to the meaning of the notation described in FIG. 4.

The labeled graph generated by the configuration prediction unit 130 as shown in FIG. 7 or a list of the labeled graphs, and the text data of the prediction source as shown in FIG. 6 are inputted to the information conversion unit 150.

The information conversion unit 150 holds a conversion algorithm for converting a labeled graph into information described in various modeling languages. Specifically, for each modeling language used to describe system configuration, the information conversion unit 150 has procedures and rules for converting abstract configuration information indicating meaning of words on the configuration and a relationship between the words predicted by the configuration prediction unit 130.

The information conversion unit 150 has a function of converting a labeled graph into information described in a modeling language specified by the user in advance. The information conversion unit 150 converts abstract configuration information into information described in a specified modeling language, in accordance with a modeling language specified by the user.

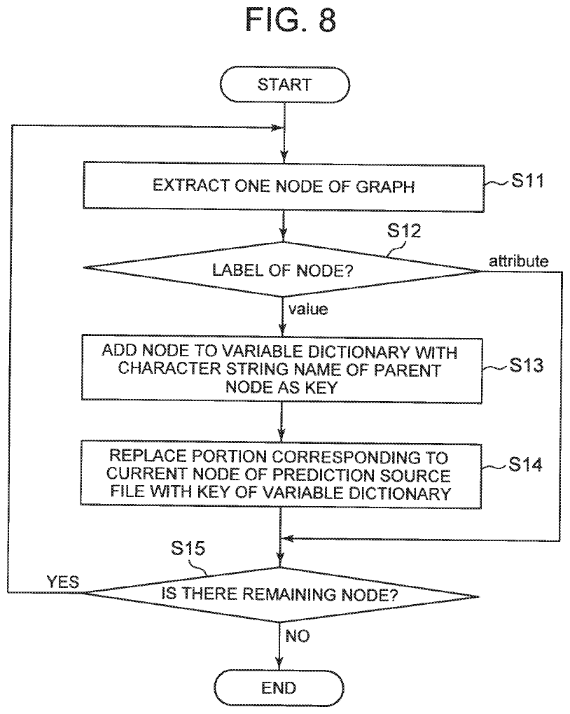

FIG. 8 is a flowchart showing an operation of a modeling language conversion process by the information conversion unit 150 of the first exemplary embodiment. The modeling language conversion process shown in FIG. 8 is performed in accordance with a conversion algorithm that reflects a conversion rule for converting a labeled graph into a template file and a variable dictionary.

First, the information conversion unit 150 extracts one node of the graph (step S11). Next, the information conversion unit 150 checks a label of the extracted node (step S12). When the checked label is “attribute” (“attribute” in step S12), the information conversion unit 150 performs processing of step S15.

When the checked label is “value” (“value” in step S12), the information conversion unit 150 adds a node as dictionary data to the variable dictionary with a parent node name of the node having the label “value” as a key (step S13).

Next, the information conversion unit 150 replaces a description portion of a current node of a prediction source file with a key of the variable dictionary of the dictionary data added in step S13 (step S14).

Next, the information conversion unit 150 checks whether or not there is a remaining node (step S15). When there is a remaining node (Yes in step S15), the information conversion unit 150 performs processing of step S11 again. When there is no remaining node (No in step S15), the information conversion unit 150 ends the modeling language conversion process.

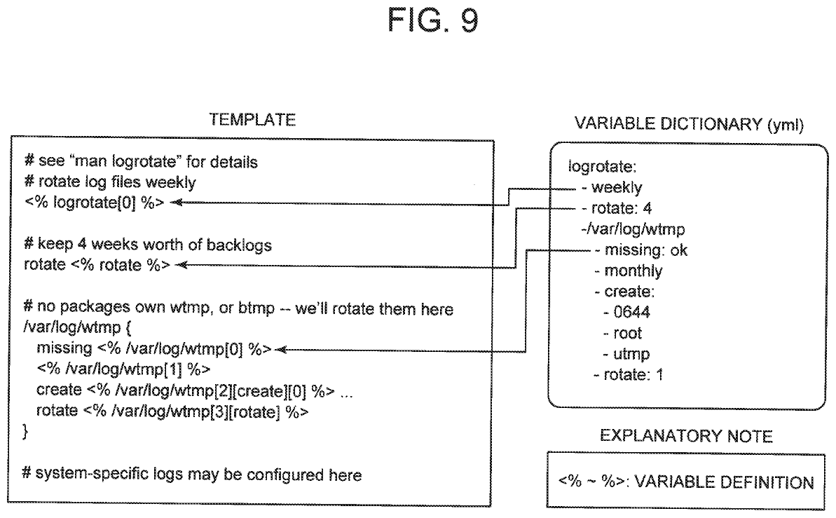

FIG. 9 shows an example of configuration information outputted by the information conversion unit 150. FIG. 9 is an explanatory diagram showing an example of a template file and a variable dictionary outputted by the information conversion unit 150. The template file and the variable dictionary shown in FIG. 9 are a template file and a variable dictionary that are generated by the modeling language conversion process shown in FIG. 8, on the basis of the text data shown in FIG. 6 and the labeled-graph data shown in FIG. 7.

In the template file shown in FIG. 9, the notation “<% %>” is used for variable definition. Further, in the variable dictionary shown in FIG. 9, yml format is used.

Note that the notation of the template file depends on a language (specification of a template engine) used by a template engine that processes the template. That is, the notation of the generated template is not limited to the notation shown in FIG. 9.

As shown in FIG. 9, three portions in the template are replaced with the keys of the variable dictionary. For example, “rotate 4” is replaced with “rotate <% rotate %>”.

Configuration information according to a specification of a specific modeling language generated by the information conversion unit 150 as shown in FIG. 9 is inputted to the configuration information output unit 160. The configuration information output unit 160 outputs the inputted configuration information as configuration information in a data format such as a file.

The configuration management device 100 according to the present exemplary embodiment handles data that is to be a generation source of configuration information described in text data, represented by configuration files, command execution results, and the like. By executing machine learning on the basis of a collection of supervised learning data unique to text data suggesting system configuration information and on the basis of characteristic (feature) data, the prediction model learning unit 120 of the configuration management device 100 generates a prediction model to be inputted with versatile configuration information whose application is not limited to specific configuration information whose format or syntax is fixed.

The configuration prediction unit 130 of the present exemplary embodiment uses the generated prediction model to generate a configuration model that is abstract (abstract configuration model) by analyzing text data that is obtained from the configuration management target and to be a generation source of configuration information.

The abstract configuration model is represented by a data structure such as a labeled graph that does not depend on a specific modeling language. The information conversion unit 150 converts the abstract configuration model into information described in a specific modeling language specified by an automatic construction tool or the like, in accordance with the user's request.

### [Description of Operation]

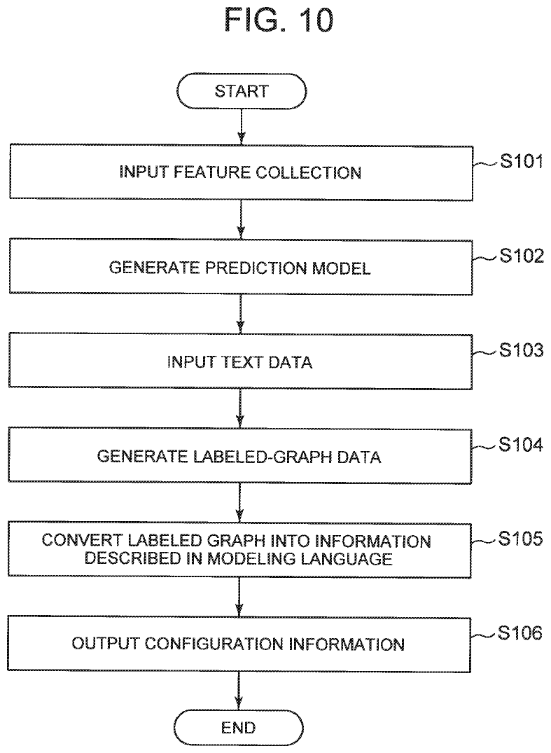

Hereinafter, an operation of outputting configuration information by the configuration management device 100 according to the present exemplary embodiment will be described with reference to FIG. 10. FIG. 10 is a flowchart showing an operation of a configuration information output process by the configuration management device 100 of the first exemplary embodiment.

First, a feature collection is inputted to the feature input unit 110 from the input device 200 (step S101). The feature input unit 110 inputs the inputted feature collection to the prediction model learning unit 120.

Next, the prediction model learning unit 120 generates a prediction model on the basis of learning data stored in the learning data storage unit 300 and the inputted feature collection (step S102). The prediction model learning unit 120 inputs the generated prediction model to the configuration prediction unit 130.

Next, text data suggesting configuration information of the management-target system 400 is inputted from the management target monitoring unit 140 to the configuration prediction unit 130 (step S103).

Next, the configuration prediction unit 130 generates labeled-graph data, on the basis of the inputted prediction model and text data (step S104). The configuration prediction unit 130 inputs the generated labeled-graph data and the text data to the information conversion unit 150.

Next, the information conversion unit 150 converts the inputted labeled graph into information described in a modeling language (step S105). The information conversion unit 150 inputs the converted information into the configuration information output unit 160.

Next, the configuration information output unit 160 outputs the inputted information as configuration information (step S106). After the output, the configuration management device 100 ends the configuration information output process.

By executing the above processing, the configuration management device 100 of the present exemplary embodiment automatically converts text data extracted from the configuration management target into configuration information conforming to a specific modeling language.

### [Description of Effect]

The prediction model learning unit 120 of the configuration management device 100 according to the present exemplary embodiment learns a prediction model, by using data indicating features unique to text data suggesting configuration information. In addition, the configuration prediction unit 130 uses the learned prediction model to convert text data suggesting configuration information such as a configuration file and a command execution result into a labeled graph.

Further, the information conversion unit 150 of the present exemplary embodiment generates configuration information according to a specification of a modeling language required by the user, on the basis of a collection of sets of text data and a labeled graph converted from the text data. Therefore, the configuration management device 100 of the present exemplary embodiment can automatically generate configuration information on the basis of text data that suggest configuration information of a configuration management target and does not depend on a specific language specification or format.

### Second Exemplary Embodiment

### [Description of Configuration]

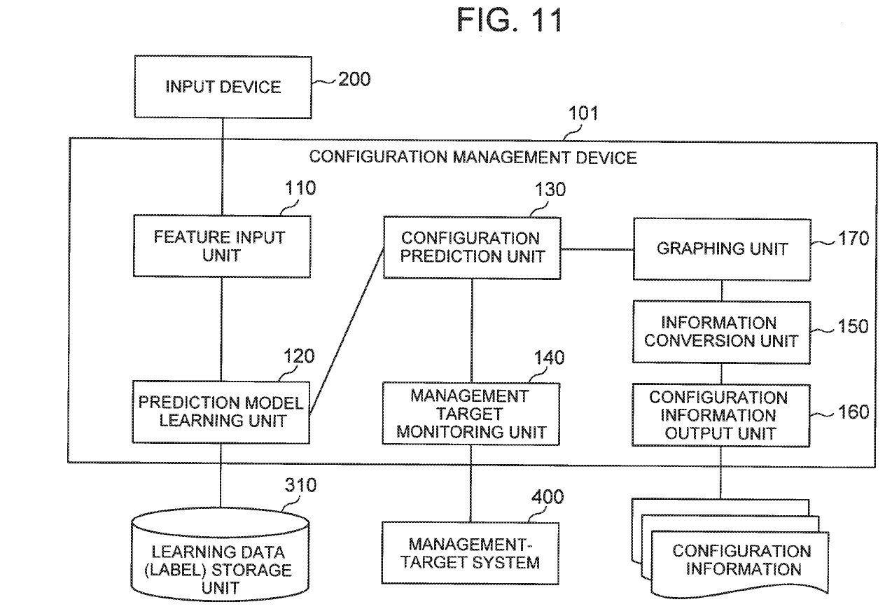

Next, a second exemplary embodiment of the present invention will be described with reference to the drawings. FIG. 11 is a block diagram showing a configuration example of the second exemplary embodiment of a configuration management device according to the present invention.

A configuration management device 101 according to the present exemplary embodiment predicts configuration information of a serial label string instead of configuration information of a labeled graph from text data suggesting configuration information.

As shown in FIG. 11, the configuration management device 101 according to the present exemplary embodiment includes a feature input unit 110, a prediction model learning unit 120, a configuration prediction unit 130, a management target monitoring unit 140, an information conversion unit 150, a configuration information output unit 160, and a graphing unit 170. A configuration of the configuration management device 101 of the present exemplary embodiment is similar to that of the configuration management device 100 of the first exemplary embodiment except for the graphing unit 170.

Unlike the configuration management device 100 of the first exemplary embodiment, the graphing unit 170 is added to the configuration management device 101 of the present exemplary embodiment. In addition, a learning data (label) storage unit 310 stores information indicating a data structure such as a label string.

The prediction model learning unit 120 of the present exemplary embodiment uses, instead of labeled-graph data, a mere label string having no graph structure and corresponding to text data, as teacher data in learning processing of a prediction model.

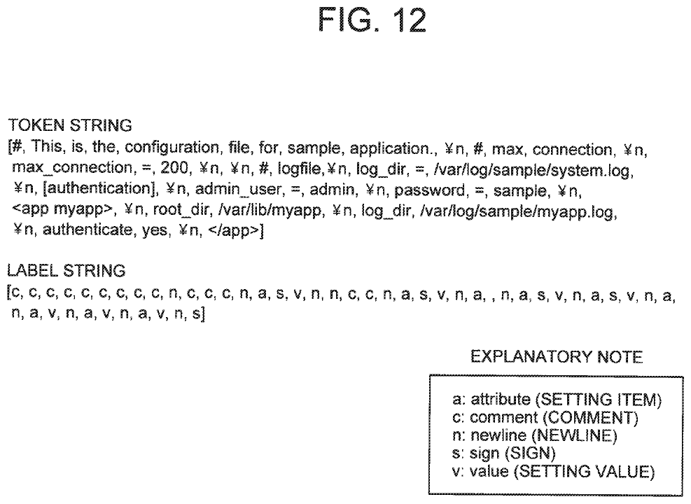

FIG. 12 is an explanatory diagram showing an example of learning data stored in the learning data (label) storage unit 310. Note that the learning data shown in FIG. 12 corresponds to the text data shown in FIG. 2.

As shown in FIG. 12, the learning data of the present exemplary embodiment is composed of a token string and a label string. The token string is data that is listed after text data such as a configuration file is disassembled into words (tokens) including a control code such as a newline.

Further, the label string is teacher data corresponding to the token string. The label string is data in which labels corresponding to respective elements in the token string are listed.

For example, a label corresponding to the fifth token “configuration” in the token string shown in FIG. 12 is also the fifth element “c” (comment) in the label string. “c” indicates that the word “configuration” is recommended to be classified as a comment character.

The prediction model learning unit 120 uses learning data as shown in FIG. 12 to learn a model for predicting a label attached to text data. The prediction model learning unit 120 inputs the learned prediction model to the configuration prediction unit 130.

The configuration prediction unit 130 uses the inputted prediction model to predict a label string corresponding to the text data received from the management target monitoring unit 140. That is, the configuration prediction unit 130 predicts meaning of each word in the given text data. Next, the configuration prediction unit 130 inputs the predicted label string to the graphing unit 170.

On the basis of the inputted label string, the graphing unit 170 outputs labeled-graph data having a data structure similar to that of the labeled-graph data outputted by the configuration prediction unit 130 of the first exemplary embodiment.

Specifically, on the basis of a list of semantics of the prediction result and the word string of the text data, the graphing unit 170 uses a distance between the words and a condition of semantics to derive a graph indicating a relationship between the words in the text data suggesting a configuration.

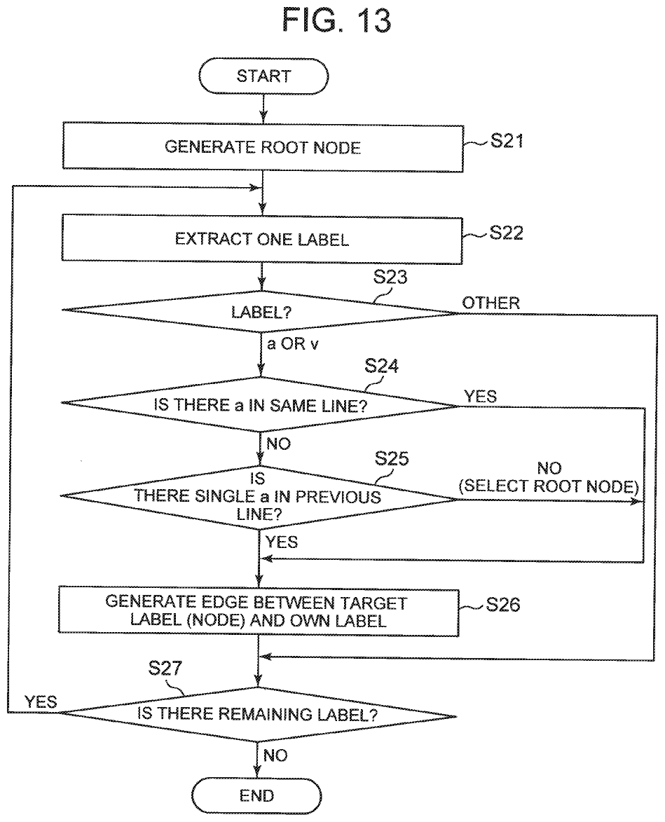

FIG. 13 is a flowchart showing an operation of a graph conversion process by the graphing unit 170 of the second exemplary embodiment.

First, the graphing unit 170 generates a root node of an outputted graph (step S21). Next, the graphing unit 170 extracts one label from the beginning of the label string (step S22).

When the extracted label is a label other than “a” (setting item) or “v” (setting value) (“other” in step S23), the graphing unit 170 performs processing of step S27.

When the extracted label is a label of “a” (setting item) or “v” (setting value) (“a or v” in step S23), the graphing unit 170 searches for a label of a token to be a parent node on the outputted graph, from among label elements existing before the extracted label. Specifically, the graphing unit 170 checks whether or not the label “a” exists in the same line (step S24).

When the label “a” exists in the same line (Yes in step S24), the graphing unit 170 regards the token with the label “a” as a parent node. Next, the graphing unit 170 generates an edge (edge of the graph) between the node of the label “a” and the node of the extracted label (step S26).

When the label “a” does not exist in the same line (No in step S24), the graphing unit 170 further searches beyond “n” (newline) and checks whether or not there is a label “a” for which no child node has been registered yet. That is, the graphing unit 170 checks whether or not a single label “a” exists in the previous line (step S25).

When there is a single label “a” in the previous line (Yes in step S25), the graphing unit 170 regards the token with the label “a” as a parent node. Then, the graphing unit 170 generates an edge between the node of the label “a” and the node of the extracted label (step S26).

When a single label “a” does not exist in the previous line (No in step S25), the graphing unit 170 regards the root node as a parent node. Next, the graphing unit 170 generates an edge between the root node and the node of the extracted label (step S26).

Next, the graphing unit 170 checks whether or not there is a remaining label in the label string (step S27). When there is a remaining label (Yes in step S27), the graphing unit 170 performs processing of step S22 again.

When there is no remaining label (No in step S27), the graphing unit 170 ends the graph conversion process. By executing the graph conversion process, the graphing unit 170 can generate labeled-graph data by using all label elements.

Note that the graph conversion process shown in FIG. 13 is an example of a process of constructing a graph structure on the basis of a label string by using the fact that a parent node satisfies a predetermined condition. The predetermined condition is, for example, “a parent node exists immediately before a node of the extracted label”, “a label of a parent node is an attribute label”, or the like.

However, the condition for selection of nodes to be used to derive a parent node from a serial label string and construct graph data is not limited to the condition described in FIG. 13.

### [Description of Operation]

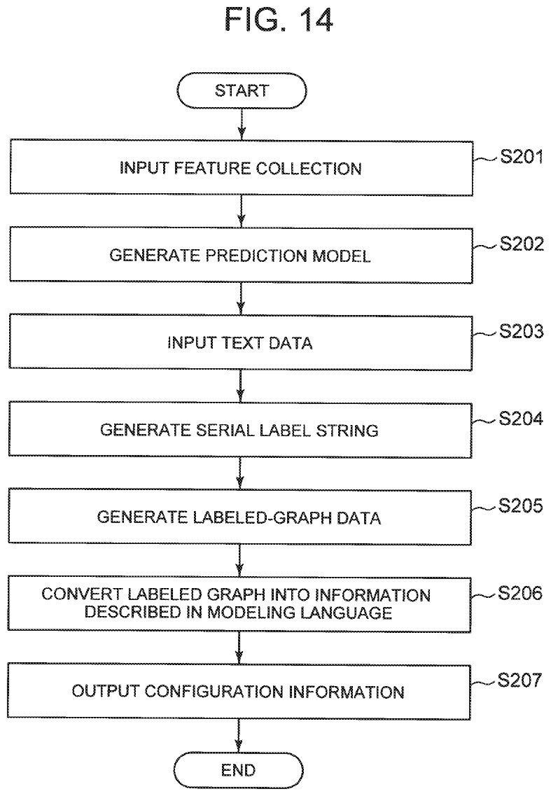

Hereinafter, an operation of outputting configuration information by the configuration management device 101 according to the present exemplary embodiment will be described with reference to FIG. 14. FIG. 14 is a flowchart showing an operation of a configuration information output process by the configuration management device 101 of the second exemplary embodiment.

The processing of step S201 to step S203 is similar to the processing of step 5101 to step S103 shown in FIG. 10.

The configuration prediction unit 130 generates a serial label string on the basis of the inputted prediction model and text data (step S204). The configuration prediction unit 130 inputs the generated serial label string and the text data to the graphing unit 170.

Next, the graphing unit 170 generates labeled-graph data on the basis of the inputted serial label string and text data (step S205). The graphing unit 170 inputs the generated labeled-graph data and the text data to the information conversion unit 150.

The processing of step S206 to step S207 is similar to the processing of step S105 to step S106 shown in FIG. 10.

### [Description of Effect]

The prediction model learning unit 120 of the configuration management device 101 according to the present exemplary embodiment learns a prediction model by using label string data that is easier to generate than a labeled graph, as teacher data. That is, the prediction model learning unit 120 can further reduce the cost when learning a prediction model.

Further, the configuration management device 101 of the present exemplary embodiment can automatically generate configuration information according to a specification of a modeling language required by the user, on the basis of text data that suggests configuration information of a configuration management target and does not depend on a specific language specification or format.

### Third Exemplary Embodiment

### [Description of Configuration]

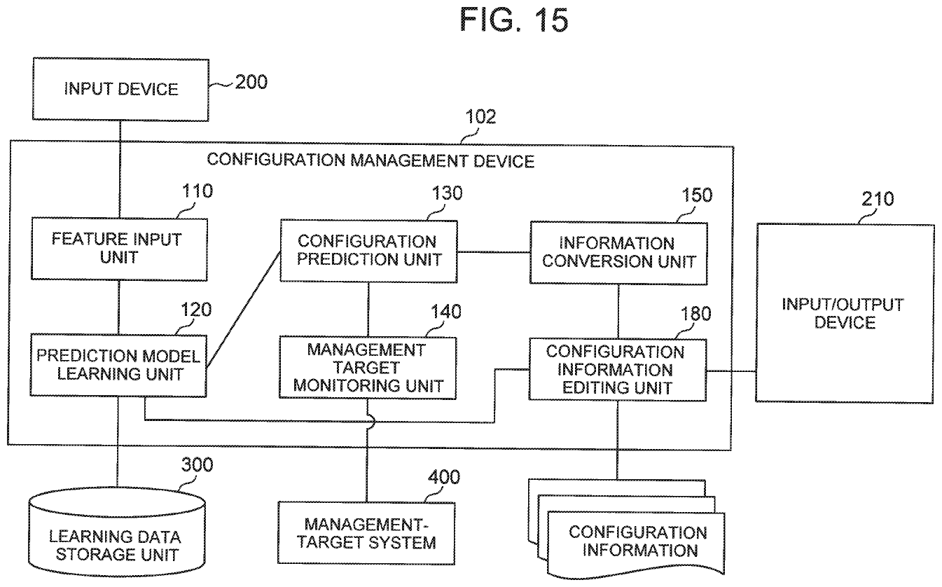

Next, a third exemplary embodiment of the present invention will be described with reference to the drawings. FIG. 15 is a block diagram showing a configuration example of the third exemplary embodiment of a configuration management device according to the present invention. In a configuration management device 102 of the present exemplary embodiment, a user can confirm and edit generated configuration information.

As shown in FIG. 15, the configuration management device 102 according to the present exemplary embodiment includes a feature input unit 110, a prediction model learning unit 120, a configuration prediction unit 130, a management target monitoring unit 140, an information conversion unit 150, and a configuration information editing unit 180. A configuration of the configuration management device 102 of the present exemplary embodiment is similar to that of the configuration management device 100 of the first exemplary embodiment except for the configuration information editing unit 180.

Unlike the configuration management device 100 of the first exemplary embodiment, the configuration management device 102 of the present exemplary embodiment is provided with the configuration information editing unit 180 instead of the configuration information output unit 160. Further, the configuration management device 102 of the present exemplary embodiment is connected to an input/output device 210.

To the configuration information editing unit 180, configuration information is inputted from the information conversion unit 150. The user refers to and updates the configuration information inputted to the configuration information editing unit 180 via the input/output device 210. After the reference and the update are performed, the configuration information editing unit 180 outputs the configuration information.

Meanwhile, learning data may be generated by the configuration information editing unit 180 inputting the changed configuration information to the information conversion unit 150, and the information conversion unit 150 inversely converting the labeled-graph data that is the inputted configuration information.

Specifically, the configuration information editing unit 180 refers to the configuration information generated by the information conversion unit 150, and corrects the configuration information in accordance with a user's request. Next, the information conversion unit 150 converts the correction result into an abstract model, and inputs the abstract model to the prediction model learning unit 120 as learning data. Next, the prediction model learning unit 120 performs learning again in accordance with the additional input of learning data, and inputs the updated prediction model to the configuration prediction unit 130.

As described above, when the generated learning data is inputted to the prediction model learning unit 120, the prediction model learning unit 120 learns the prediction model again. That is, the prediction model used by the configuration prediction unit 130 is updated.

### [Description of Operation]

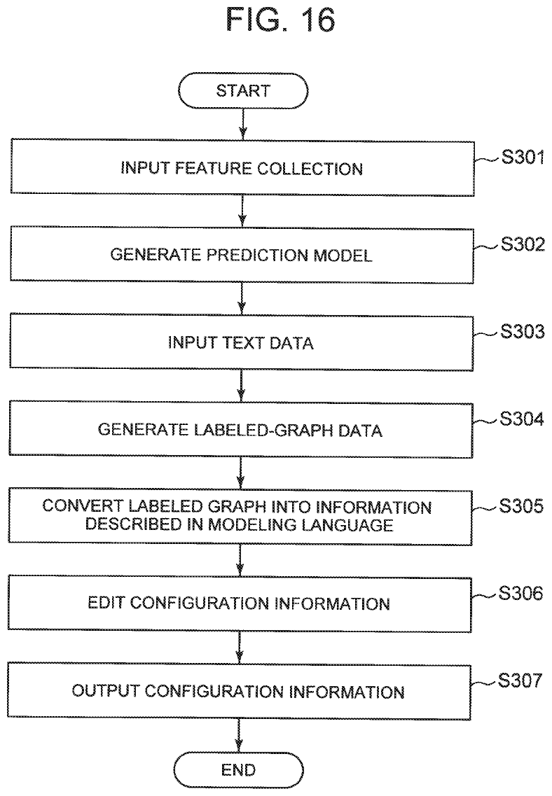

Hereinafter, an operation of outputting configuration information by the configuration management device 102 according to the present exemplary embodiment will be described with reference to FIG. 16. FIG. 16 is a flowchart showing an operation of a configuration information output process by the configuration management device 102 of the third exemplary embodiment.

The processing of step S301 to step S305 is similar to the processing of step 5101 to step S105 shown in FIG. 10.

The configuration information editing unit 180 edits the inputted configuration information in accordance with an instruction inputted from the input/output device 210 (step S306). Next, the configuration information editing unit 180 outputs the edited configuration information (step S307). After the output, the configuration management device 102 ends the configuration information output process.

### [Description of Effect]

When there is an error in part of the generated configuration information, a user who uses the configuration management device 102 of the present exemplary embodiment can use the entire configuration information that has been automatically generated, simply by correcting a relevant portion through the configuration information editing unit 180.

In addition, by the prediction model learning unit 120 automatically learning the corrected content, possibility of the occurrence of a similar error is reduced from the next time. That is, the accuracy of the generated prediction model is further enhanced.

A user who uses the configuration management device of each exemplary embodiment can acquire configuration management information according to a predetermined modeling language, for components of a system that manages a configuration. The user does not need to instruct a procedure and a method for analyzing text data that suggests configuration information and is obtained from the configuration management target for each specific element, to the configuration management device finely and accurately.

Note that the configuration management device 100 to the configuration management device 102 of the respective exemplary embodiments may be realized, for example, by a central processing unit (CPU) that executes processing in accordance with a program stored in a non-transitory storage medium. That is, the feature input unit 110, the prediction model learning unit 120, the configuration prediction unit 130, the management target monitoring unit 140, the information conversion unit 150, the configuration information output unit 160, the graphing unit 170, and the configuration information editing unit 180 may be realized, for example, by the CPU that executes processing according to program control.

Further, the learning data storage unit 300 and the learning data (label) storage unit 310 may be realized by, for example, a random access memory (RAM).

Further, each unit in the configuration management device 100 to the configuration management device 102 of the respective exemplary embodiments may be realized by a hardware circuit. As an example, the feature input unit 110, the prediction model learning unit 120, the configuration prediction unit 130, the management target monitoring unit 140, the information conversion unit 150, the configuration information output unit 160, the graphing unit 170, and the configuration information editing unit 180 each are realized by large scale integration (LSI). In addition, they may be realized by one LSI.

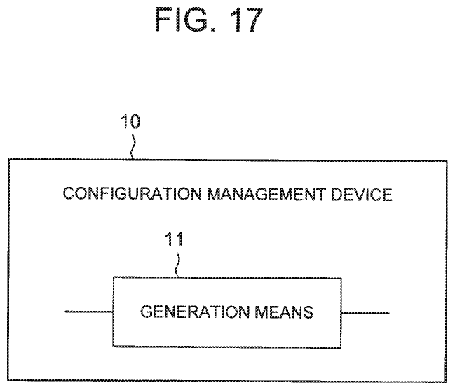

Next, an outline of the present invention will be described. FIG. 17 is a block diagram showing an outline of a configuration management device according to the present invention. A configuration management device 10 according to the present invention includes a generation means 11 (for example, the prediction model learning unit 120) that executes supervised machine learning on the basis of feature information that indicates the features of text data in which configuration information of a system is included and learning data in which the text data and the configuration information of the system are included, and thereby generates a prediction model used in predicting the configuration information of a system included in input data from input data that is the text data having the features indicated by the feature information.

Such a configuration enables the configuration management device to grasp configuration management information from an unknown configuration management target at low cost.

Further, the configuration management device 10 may include a prediction means (for example, the configuration prediction unit 130) that predicts the configuration information on the basis of a generated prediction model and input data that is text data including configuration information of a management-target system.

Such a configuration enables the configuration management device to grasp configuration information of the management-target system with use of the generated prediction model.

Further, the configuration management device 10 may further include a conversion means (for example, the information conversion unit 150) that converts predicted configuration information into information described in a predetermined language in accordance with a conversion rule corresponding to the predetermined language.

Such a configuration enables the configuration management device to output configuration information described in a modeling language specified by the user.

Further, the configuration management device 10 may include an input means (for example, the configuration information editing unit 180) to be inputted with an instruction to edit information described in a predetermined language, and the input means may edit information described in a predetermined language in accordance with an inputted instruction.

Such a configuration enables the configuration management device to easily correct an error present in the generated configuration information.

In addition, the generation means 11 may update a generated prediction model with use of edited information described in a predetermined language.

Such a configuration enables the configuration management device to further improve the accuracy of the generated prediction model.

Further, the prediction means may output predicted configuration information of the management-target system in a predetermined format.

Such a configuration enables the configuration management device to predict configuration information that is labeled-graph data.

Although the present invention has been described with reference to the exemplary embodiments and examples, the present invention is not limited to the above exemplary embodiments and examples. Various changes that can be understood by those skilled in the art can be made to the configuration and details of the present invention within the scope of the present invention.

This application claims priority based on Japanese Patent Application 2017-058727, filed Friday, Mar. 24, 2017, the entire disclosure of which is incorporated herein.

### INDUSTRIAL APPLICABILITY

The present invention is suitably applied to a system configuration management tool that automatically detects failure or change in a system, or automatically adds a function or updates a function. Further, the present invention is also suitably applied to application examples of reverse engineering tool products for visualizing design contents of a constructed system and designing a new system on the basis of the visualized design contents.

### REFERENCE SIGNS LIST

10, 100 to 102 Configuration management device
11 Generation means
110 Feature input unit
120 Prediction model learning unit
130 Configuration prediction unit
140 Management target monitoring unit
150 Information conversion unit
160 Configuration information output unit
170 Graphing unit
180 Configuration information editing unit
200 Input device
210 Input/output device
300 Learning data storage unit
310 Learning data (label) storage unit
400 Management-target system

1. A configuration management device comprising:
a generation unit that executes supervised machine learning on the basis of feature information that indicates the features of text data in which configuration information of a system is included and learning data in which the text data and the configuration information of the system are included, and thereby generates a prediction model used in predicting the configuration information of a system included in input data from input data that is the text data having the features indicated by the feature information.

2. The configuration management device according to claim 1, further comprising:
a prediction unit that predicts the configuration information on the basis of a generated prediction model and input data that is text data including configuration information of a management-target system.

3. The configuration management device according to claim 2, further comprising:
a conversion unit that converts predicted configuration information into information described in a predetermined language in accordance with a conversion rule corresponding to the predetermined language.

4. The configuration management device according to claim 3, further comprising:
an input unit to be inputted with an instruction to edit information described in a predetermined language, wherein
the input unit edits information described in a predetermined language in accordance with an inputted instruction.

5. The configuration management device according to claim 4, wherein
the generation unit updates a generated prediction model with use of edited information described in a predetermined language.

6. The configuration management device according to claim 2, wherein
the prediction unit outputs predicted configuration information of the management-target system in a predetermined format.

7. A configuration management method comprising:
executing supervised machine learning on the basis of feature information that indicates the features of text data in which configuration information of a system is included and learning data in which the text data and the configuration information of the system are included, and thereby generating a prediction model used in predicting the configuration information of a system included in input data from input data that is the text data having the features indicated by the feature information.

8. The configuration management method according to claim 7, further comprising:
predicting the configuration information on the basis of a generated prediction model and input data that is text data including configuration information of a management-target system.

9. A non-transistory computer readable recording medium with
a recorded configuration management program that executes,
when executed on a computer,
supervised machine learning on the basis of feature information that indicates the features of text data in which configuration information of a system is included and learning data in which the text data and the configuration information of the system are included, and thereby generates a prediction model used in predicting the configuration information of a system included in input data from input data that is the text data having the features indicated by the feature information.

10. The recording medium according to claim 9, further comprising:
when executed on a computer,
predicting the configuration information on the basis of a generated prediction model and input data that is text data including configuration information of a management-target system.

11. The configuration management device according to claim 3, wherein
the prediction unit outputs predicted configuration information of the management-target system in a predetermined format.

12. The configuration management device according to claim 4, wherein
the prediction unit outputs predicted configuration information of the management-target system in a predetermined format.

13. The configuration management device according to claim 5, wherein
the prediction unit outputs predicted configuration information of the management-target system in a predetermined format.
